(19) United States
(12) Patent Application Publication
(10) Pub. No.: US 2015/0203233 A1
(43) Pub. Date: Jul. 23, 2015

(54) SLEEVE LABELING MACHINE

(71) Applicant: ALLEN PLASTIC INDUSTRIES CO., LTD., Kaohsiung City (TW)

(72) Inventor: KENNETH WANG, KAOHSIUNG CITY (TW)

(73) Assignee: ALLEN PLASTIC INDUSTRIES CO., LTD., Kaohsiung City (TW)

(21) Appl. No.: 14/271,017

(22) Filed: May 6, 2014

(30) Foreign Application Priority Data
Jan. 23, 2014 (TW) 103102503

(51) Int. Cl. B65C 3/06

(52) U.S. Cl. CPC B65C 3/065

(57) ABSTRACT

This invention is related to a sleeve labeling machine, which includes a center column, a transmission device, and a cutter device. The said center column can unfold the shrink film, and a roll of the transmission device will carry the shrink film and let the said shrink film sleeve the center column Then, the said cutter device will cut the shrink film, and another roll of transmission device will keep pulling each cut shrink film to cover the surface of a bottle or a can. Finally, the transmission device will convoy bottles or cans to the next device, and let the shrink film combine with the bottle or the can to complete the bottle or can sleeve labeling process.

### CROSS-REFERENCE TO RELATED APPLICATIONS

This application claims priority to Taiwan Patent Applications No. 103102503, filed on Jan. 23, 2014, the content of which is incorporated herein by reference in its entirety.

### FIELD OF THE INVENTION

This invention is related to a sleeve labeling machine, particularly referring to a shrink film synchronous transmission device with label feeding rollers and label pulling rollers equipped between upper and lower portion of a cutter device. By label feeding rollers, the guide shrink film will be continued to guide down, and after the shrink film was cut by the cutter device, label pulling rollers will continue pulling each shrink film to cover the surface of bottles or cans, in order to prevent wrinkles produced by each shrink film to hinder conveyance and ensure the sleeve labeling machine can accurately sleeve the shrink film on cans or bottles.

### DESCRIPTION OF RELATED ART

As the currently marketed sleeve labeling machine, such as the “Hot Shrink Film Guide Mechanism”, a new model of publication No. 379728, mainly the feeding rollers are set surrounding at upper, middle and lower center guide column of the frame respectively; a guide roller is set at the feeding roller set corresponding to the center guide column, and a cutter device is set near the lower center guide column, and then a cutting roller is set near the lower of center guide; an adjustment roller is set at the side of feeding roller set base, between which two guide rods are set; a shaft lever is set between two guide rods; the opposite reverse threads are set at the two ends of the shaft lever, and on the opposite reverse threads, two guide blocks are set respectively; below the guide blocks, two wheel seats are fixed respectively; the wheel seat is equipment with feeding rollers, and the rear end of which is equipped with a pulley and a linkage; each feeding roller's pulley is equipped with a drive belt, and then the entire mechanism can be operated driving by a motor. In other words, the foregoing prior art, primarily by three feeding roller sets at upper, middle and lower center guide column, guide the shrink film on the center guide column to move down; its sole purpose is to make feeding rollers of three seeding roller sets to match the diameter of center guide column so as to adjust the set position, and let the entire mechanism with the shape of cans or bottles show different setting angle, but how to conduct accurate conveyance if the thickness of shrink film subject to change is really in doubt.

To this end, the present inventor with many years of experience in the design and manufacture of related equipment, studied the structure problem especially for the foregoing prior art to carry out this invention. In addition, this invention need two guide roller sets only, placed at upper and lower cutter device respectively for synchronous operation.

### SUMMARY

The purpose of this invention is to provide a conveyance applied on the shrink film with a variety of thickness, to overcome the quality problem of shrink film, and accurately sleeve the shrink film on cans or bottles. It is an innovative sleeve labeling machine. To achieve the foregoing object, the sleeve labeling machine of this invention includes a shrink film synchronous transmission device at center column equipped with a label feeding roller set to continuously convey the shrink film down and gradually cover the center column, and after which is cut by a cutter device, anther label pulling roller set synchronously continues pulling each shrink film down, in order to accurately cover the surface of cans or bottles.

The sleeve labeling machine of this invention is mainly centered with the center column, and the label feeding rollers and the label pulling rollers of the shrink film synchronous transmission device are set at upper and lower cutter device respectively, so that the foregoing label feeding rollers and label pulling rollers produce a synchronous feeding and pulling action against shrink film; even very thin shrink film is not difficult to produce wrinkles, each shrink film can completely cover the surface of cans or bottles.

### BRIEF DESCRIPTION OF THE DRAWINGS

FIG. 1 is a partial front view of the sleeve labeling machine of this invention.

FIG. 2 is a partial side view of the sleeve labeling machine of this invention.

FIG. 3 is a partial rear view of the sleeve labeling machine of this invention.

FIG. 4 is a partial operation view of the sleeve labeling machine of this invention.

### DESCRIPTION OF SYMBOLS

A center column 1, the first column 1a, the second column 1b, a cutter trough 1c, a shrink film unfolding sheet 10, the first guide pulleys 11, the second guide pulleys 12, the first passive guide rollers 110, the second passive guide rollers 120, a shrink film A

A shrink film synchronous transmission device 2, label feeding rollers 20, label pulling rollers 21, power equipment 22, transmission belts 220a, 220b, 221a, 221b, the first passive label feeding guide rollers 200a, the second passive label feeding guide rollers 200b, passive label pulling guide rollers 210, triangle label feeding space 200c, cutter device 3.

### DETAILED DESCRIPTION OF EMBODIMENTS

Herein below preferred the sleeve labeling machine of this invention will be described in detail with reference to the accompanying drawings.

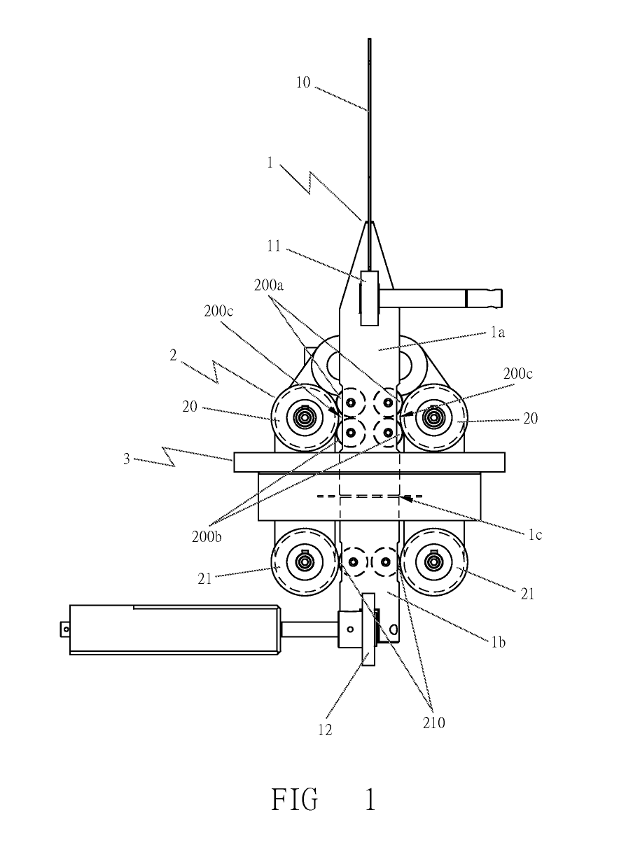

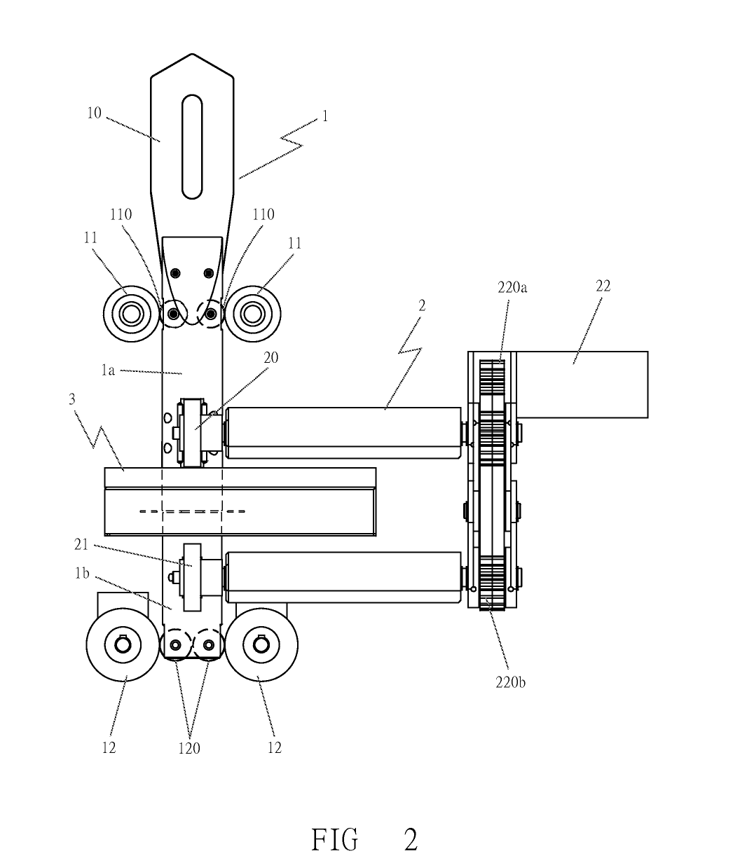

As shown in FIGS. 1 and 2, the sleeve labeling machine of this invention includes at least a center column 1, equipping with the first column 1a and the second column 1b, and a cutter trough 1c between the first column 1a and the second column 1b; a shrink film unfolding sheet 10 is fixed on the top of the foregoing first column 1a, so that the shrink film sheet A, can be unfolded via the foregoing shrink film unfolding sheet 10; the first guide pulleys 11 and the second guide pulleys 12 are set at two sides of foregoing center column 1; the foregoing first guide pulleys 11 and the second guide pulleys 12 are two sets mounted in front and rear sides of the foregoing center column 1; the most ideal is the foregoing two first guide pulleys sets 11 and the foregoing two second guide pulley sets 12 form a corresponding linear state each other. The foregoing first guide pulleys 11 are set at the first column 1a of the foregoing center column 1, and the foregoing second guide pulleys 12 are set at the second column 1b of the foregoing center column 1; the foregoing first guide pulleys 11 are passive rollers, which can drive synchronously the foregoing first guide pulleys 11 to turn when the shrink film is guided down. The foregoing second guide pulleys 12 are set with an axle as power element to drive (belonging to conventional technology, so not shown in the figure), enabling the foregoing second guide pulleys 12 to turn. The first passive guide rollers 110 and the second passive guide rollers 120 are set within the foregoing center column 1, against the corresponding position of the foregoing first guide pulleys 11 and the second guide pulleys 12; the first passive guide rollers 110 are in contact with the foregoing first guide pulleys 11, and the foregoing second passive guide rollers 120 are in contact with the foregoing second guide pulleys 12. By label feeding rollers 20 and passive guide rollers 200, the unfolded shrink film is pulled down, along with the center column 1, to the lowest end of the center column 1, then pushing by the foregoing second guide pulleys 12 and the second passive guide rollers 120, the shrink film is completed sleeved on cans or bottles. In addition, the foregoing first guide pulleys 11 and the second guide pulleys 12, and the label feeding rollers 20 and label pulling rollers 21 of the shrink film synchronous transmission device 2 can be set at vertical position; by the foregoing first guide pulleys 11, the second guide pulleys 12, and the label feeding rollers 20 and the label pulling rollers 21 of the shrink film synchronous transmission device 2 in contract with the cross shaft plane of the shrink film, the shrink film can be guided to move down smoothly.

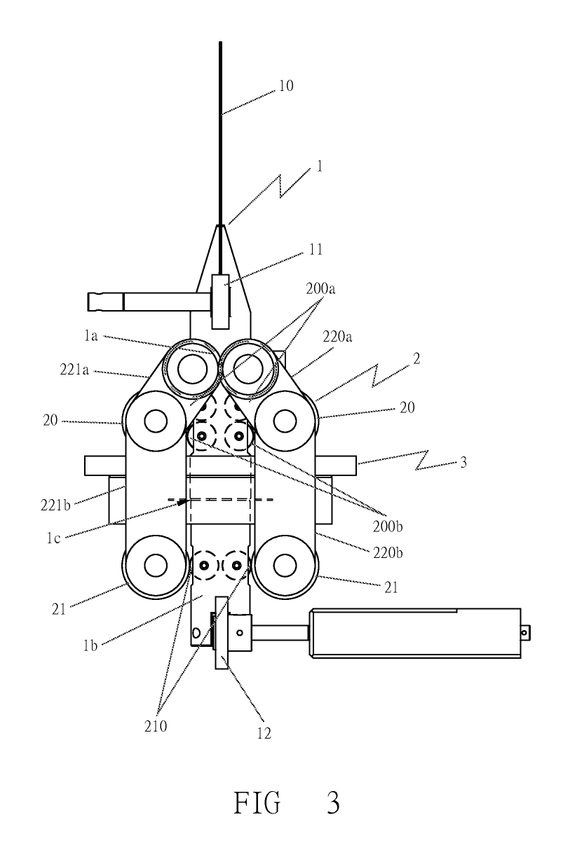

As shown in FIGS. 1 and 2, the shrink film synchronous transmission device 2 is set in the middle of the foregoing center column 1, and between the foregoing first guide pulleys 11 and the second guide pulleys 12. The foregoing shrink film synchronous transmission device 2 is equipped with label feeding rollers 20 and label pulling rollers 21; there are two sets of the foregoing label feeding rollers 20 and two sets of label pulling rollers 21 mounted at right and left sides respectively of the foregoing center column 1, and the most ideal is presenting by corresponding linear state. The foregoing label feeding rollers 20 are set beside the first column 1a of the center column 1, at the top of the cutter device 3. And the foregoing label pulling rollers 21 are set at the side of the second column 1b of the center column 1, below the foregoing cutter device 3; the foregoing label feeding rollers 20 and the label pulling rollers 21 using power equipment 22 to drive the mandrel (belonging to conventional, no repeat), then with transmission belts 220a, 220b, 221a, and 221b set around the corresponding axles (as FIGS. 2 and 3), to produce the effect of synchronous transmission of label feeding rollers 20 and label pulling rollers 21, so that the foregoing label feeding rollers 20 and label pulling rollers 21 may turn synchronously, and enable the shrink film conveyed down by foregoing label feeding rollers 20 to be successfully joined and pulled by label pulling rollers 21, so that this invention can successfully guide and convey the shrink film with a variety of thickness; the first passive label feeding guide rollers 200a, the second passive label feeding guide rollers 200b, and the passive label pulling guide rollers 210 are set within the foregoing center column 1, against the corresponding position of the foregoing label feeding rollers 20 and label pulling rollers 21, namely, the foregoing first passive label feeding guide rollers 200a, and the second passive label feeding guide rollers 200b are set in the first column 1a, and the foregoing passive label pulling guide rollers 210 are set in the second column 1b of the center column 1; by two points of the foregoing first passive label feeding guide rollers 200a and the second passive label feeding guide rollers 200b in contact with the foregoing label feeding rollers 20, forms a triangle label feeding space 200c, so that the shrink film can be successfully pulled by the label feeding rollers 20, the first passive label feeding guide rollers 200a, and the second passive label feeding guide rollers 200b, and guided to convoy down by the center column 1 as axle; the foregoing passive label pulling guide rollers 210 and the foregoing label pulling rollers 21 at linear contact can continuously produce appropriate pull force to a single shrink film sheet which is convoyed by the label feeding rollers and cut by the cutter device. Thus, by the triangle label feeding space 200c, which is formed by two points produced by the first passive label feeding guide rollers 200a and the second passive label feeding guide rollers 200b in contact with the foregoing label feeding rollers 20, create the force to convey the shrink film down, and by the label pulling rollers 21 and passive label pulling guide rollers 210, the single shrink film sheet continuously conveyed from the foregoing label feeding rollers 20, the first passive label feeding guide rollers 200a, and the second passive label feeding guide rollers 200b, and after being cut by the cutter device is enough to prevent from wrinkles, so that the shrink film with variety of thickness can be successfully convoyed down to the lowest end of the center column 1, and then pushed by the foregoing second guide pulleys 12 and the second passive guide rollers 120, the shrink film can completely cover cans or bottles.

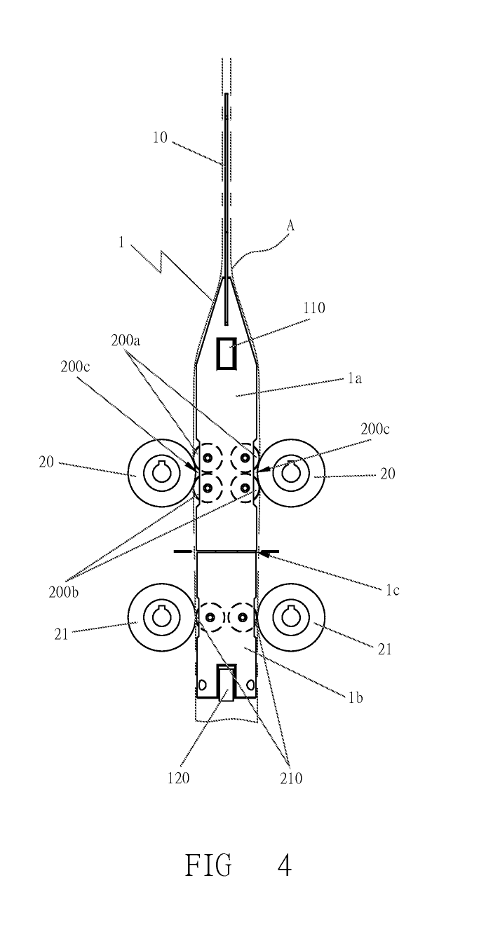

As shown in FIGS. 1, 3 and 4, the cutter trough 1 c of the foregoing center column 1 is equipped with a cutter device 3; the shrink film which has been convoyed by the foregoing label feeding rollers 20 and the passive label feeding guide rollers 200a and 200b will be cut by the foregoing cutter device 3, and then continuously pulled by the foregoing label pulling rollers 21 and passive label pulling guide rollers 210 (as shown in FIG. 4), to form a single shrink film sheet at the second column 1b of the foregoing center column 1, so that the shrink film with a variety of thickness can be successfully conveyed down, and pushed by the foregoing the second guide pulleys 12 and the second passive guide rollers 120, the shrink film can completely cover cans or bottles. In summary, the sleeve labeling machine of this invention is equipped with label feeding rollers 20 and label pulling rollers 21 in the first column 1a and in the second column 1b of the center column 1 respectively, and a cutter device is set between the foregoing label feeding rollers 20 and label pulling rollers 21, in order to cut a single shrink film sheet, and the label pulling rollers continue to pull the single shrink film sheet down. Hence, this invention can operate matching shrink film with a variety of thickness, in order to prevent each shrink film cut producing the wrinkles hindering conveyance and ensure the sleeve labeling machine enables the shrink film to accurately cover cans or bottles. These are advanced components of this invention.

What is claimed is:

1. A sleeve labeling machine includes at least a shrink film synchronous transmission device equipped with label feeding rollers and label pulling rollers, which can produce a synchronous guide and conveyance by feeding and pulling action against the shrink film on the center column The foregoing label feeding rollers are set at the side of the first column of the center column, and at the top of the cutter device; the foregoing label pulling rollers are set at the side of the second column of the center column, and below the foregoing cutter device. The foregoing label feeding rollers can convey the shrink film on the center column down, and after the label pulling rollers pulling synchronously, the foregoing shrink film can be cut by the cutter device, forming a single shrink film sheet at the second column of the foregoing center column, and then the foregoing label pulling rollers synchronously continues pulling each shrink film down, so that the shrink film can accurately cover the surface of cans or bottles as a shrink packaging.

2. According to the sleeve labeling machine set forth in claim 1, wherein the first guide pulleys and the second guide pulleys are set at sides of the center column; the foregoing first guide pulleys and the second guide pulleys are two sets mounted in front and rear sides of the foregoing center column respectively; the foregoing first guide pulleys are set in the first column of the center column, and the foregoing second guide pulleys are set in the second column of the center column; the foregoing second guide pulleys are equipped with axles as power elements for drive; the first passive guide rollers and the second passive guide rollers are set within the foregoing center column, against the corresponding position of the foregoing first guide pulleys and the second guide pulleys; the foregoing first passive guide rollers are in contact with the foregoing first guide pulleys, and the foregoing second passive guide rollers are in contact with the foregoing second guide pulleys to form an appropriate force pulling the shrink film.

3. According to the sleeve labeling machine set forth in claim 2, wherein the first guide pulleys and the second guide pulleys, and the label feeding rollers of the shrink film synchronous transmission device are set at vertical position; by the foregoing first guide pulleys, the second guide pulleys, and the label feeding rollers and the label pulling rollers of the shrink film synchronous transmission device in contact with the cross shaft plane of the shrink film, can successfully guide to move the shrink film down.

4. According to the sleeve labeling machine set forth in claim 1, wherein two sets of label the feeding rollers and two sets of the label pulling rollers shrinks of the film synchronous transmission device are mounted at the right and left sides respectively of the center column and form a corresponding linear state.

5. According to the sleeve labeling machine set forth in claim 4, wherein the label feeding rollers and the label pulling rollers shrinks of the shrink film synchronous transmission device drive the mandrel by the power equipment, then with transmission belts set around the corresponding axles, in order to produce the effect of synchronous transmission of label feeding rollers and label pulling rollers, so that the shrink film convoyed down by foregoing label feeding rollers can be successfully joined and pulled by label pulling rollers, so that his invention can successfully guide and convey the shrink film with a variety of thickness.

6. According to the sleeve labeling machine set forth in claim 4, wherein the first passive label feeding guide rollers, the second passive label feeding guide rollers, and the passive label pulling guide rollers are set within the center column, against the corresponding position of the label feeding rollers and the label pulling rollers; the foregoing first passive label feeding guide rollers, and the second passive label feeding guide rollers are set in the first column, and the foregoing passive label pulling guide rollers are set in the second column of the center column; by two points of the foregoing first passive label feeding guide roller and the second passive label feeding guide rollers in contact with the label feeding roller, forms a triangle label feeding space, so that the shrink film can be successfully pulled by the label feeding rollers, the first passive label feeding guide rollers, and the second passive label feeding guide rollers, and guided to convoy down by the center column as axle; the foregoing passive label pulling guide rollers and the foregoing label pulling rollers at linear contact can continue producing appropriate pull force to a single shrink film sheet which is convoyed by the label feeding rollers and cut by the cutter device.
